(19) United States
(12) Patent Application Publication
(10) Pub. No.: US 2008/0204781 A1
(43) Pub. Date: Aug. 28, 2008

(54) System for imaging printing forms

(75) Inventors: Robert Kersch, Augsburg (DE); Dirk Probian, Gablingen/Lutzelburg (DE)

Correspondence Address: COHEN, PONTANI, LIEBERMAN & PAVANE LLP, 551 FIFTH AVENUE, SUITE 1210, NEW YORK, NY, 10176, US

(73) Assignee: MAN Roland Druckmaschinen AG

(21) Appl. No.: 12/072,162

(22) Filed: Feb. 25, 2008

(30) Foreign Application Priority Data
Feb. 24, 2007 (DE) 10 2007 009 091.0

(51) Int. Cl. H04N 1/40

(52) U.S. Cl. 358/1.9

(57) ABSTRACT

A system for imaging printing forms includes a raster image processor breaking down a printing image data set into color separation data sets, a data storage medium for storing the color separation data sets generated by the raster image processor, the color separation data sets being printing location-nonspecific color separation data sets, and control devices and imaging devices. For the imaging of a printing form on the basis of one of the color separation data sets, each of the control devices drives one of the imaging devices to image the printing form in question. The system also includes a correction device integrated into each of the control devices to convert the printing location-nonspecific color separation data sets stored in the data storage medium into printing location-specific color separation data sets, which can be used to drive the imaging devices.

### BACKGROUND OF THE INVENTION

1. Field of the Invention

The invention pertains to a system for imaging printing forms with a raster image processor for breaking down a printing image data set into color separation data sets, a storage medium for storing the color separation data sets, and control devices driving respective imaging devices.

2. Description of the Related Art

When printing is carried out with rigid printing forms, a distinction is made in principle between methods which work with write-once printing forms and those which work with rewritable printing forms. Printing methods which use rewritable printing forms are referred to by the phrase “computer-to-press/direct imaging” printing methods.

Under the product name “DICOweb”, the applicant markets digital printing presses, which work with rewritable and erasable printing forms. When printing forms according to the DICOweb technology are used, a printing form carrier, i.e., a printing form cylinder, is subjected to an imaging step. Imaging of the printing form may be followed by the fixing and conditioning of the imaged printing form. The basic principles of the DICOweb technology are known from Helmut Kipphan: Handbuch der Printmedien [Printing Media Manual], Springer-Verlag, 2000, pp. 674-680.

An imaging unit is used to image a rewritable printing form, that is, to image the printing form in question in an image data-oriented manner. According to the DiCOweb technology, an imaging device is used to apply imaging material by a thermal transfer process to the printing form carrier. According to the prior art, a control device is used to control the imaging device by means of which a printing form can be imaged. This control device is assigned to the imaging device and drives the imaging device in question on the basis of a color separation data set.

As done in practice, color separation data sets are obtained from a printing image data set by a raster image processor. The color separation data sets provided by the raster image processor are then converted by a correction device into printing location-specific color separation data sets, which ultimately are stored in a data storage medium. The printing location-specific color separation data sets stored in the data storage medium are made available to control devices, where each control device drives an imaging device to image a printing form.

In the systems known from practice for the imaging of printing forms, therefore, a raster image processor and a correction device are used to generate printing location-specific color separation data sets. These printing location-specific color separation data sets are then assigned to control devices, which drive imaging devices for imaging the printing forms. According to standard practice, therefore, the printing location-specific color separation data sets are provided sequentially in a central correction device.

### SUMMARY OF THE INVENTION

An object of the present invention is to provide a novel system for imaging printing forms.

The object of the present invention is met by a system for imaging printing forms having a correction device integrated into each control device to convert the printing location-nonspecific color separation data sets stored in the data storage medium into printing location-specific color separation data sets, which can be used to drive the imaging devices.

In the inventive system for imaging printing forms, the printing location-specific color separation data sets are provided decentrally, where corresponding correction devices are integrated into the control devices which serve to drive the imaging devices. In the inventive system for imaging printing forms, therefore, printing location-nonspecific color separation data sets are stored in the data storage medium. The actual correction or adaptation of the printing location-nonspecific color separation data sets to the geometric characteristics of the printing press is not conducted until the data arrive in the control devices. It is therefore done in a decentralized and parallelized manner.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention is explained in greater detail below on the basis of the drawing, but the invention is not be considered limited to it:

FIG. 1 is a functional block diagram of a system for imaging printing forms according to the prior art; and

FIG. 2 is a functional block diagram of an inventive system for imaging printing forms.

### DETAILED DESCRIPTION OF THE PRESENTLY PREFERRED EMBODIMENTS

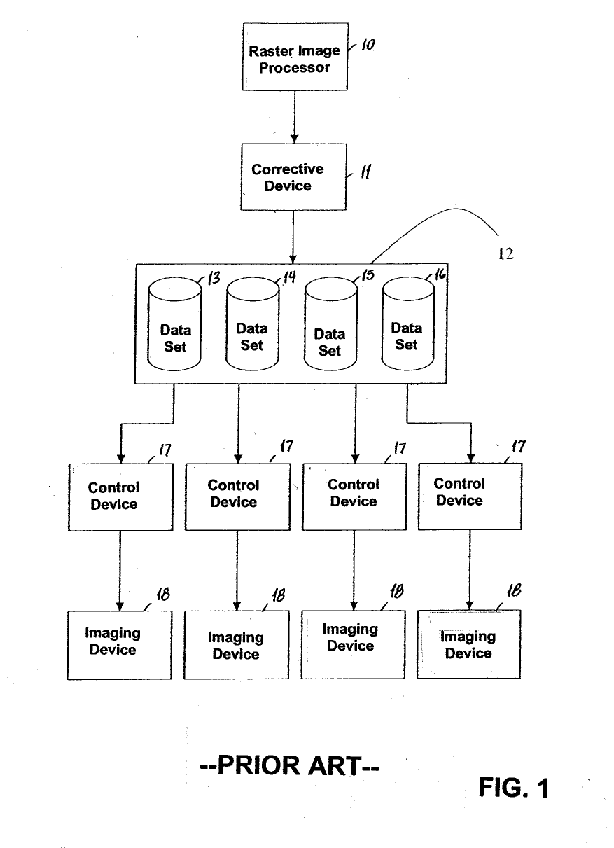

The present invention pertains to a system for imaging printing forms. Before the inventive system for imaging printing forms is discussed, a system for imaging printing forms according to the prior art will be described on the basis of FIG. 1.

FIG. 1 thus shows a system for imaging printing forms as known from the prior art and including a raster image processor 10, which breaks down a printing image data set into color separation data sets.

A color separation data set is generated for each color of ink participating in the printing process. If, thereafter, combined autotype printing is carried out with the use of the colors cyan, magenta, yellow, and black, the raster image processor 10 will provide four color separation data sets. The technique known from the prior art for imaging printing forms also has a correction device 11, which generates, centrally and sequentially, printing location-specific color separation data sets from the printing location-nonspecific color separation data sets provided by the raster image processor 10. The corrected, i.e., printing location-specific, color separation data sets thus generated are stored in a data storage medium 12. According to FIG. 1, four corrected, printing location-specific color separation data sets 13, 14, 15, and 16 are stored in the data storage medium 12. Each of the printing location-specific color separation data sets 13, 14, 15, and 16 stored in the storage medium 12 is transmitted to a control device 17, which drives an imaging device 18 on the basis of the corresponding color separation data set. The imaging device 18 is used to apply imaging material to the printing form to be imaged for the color separation in question.

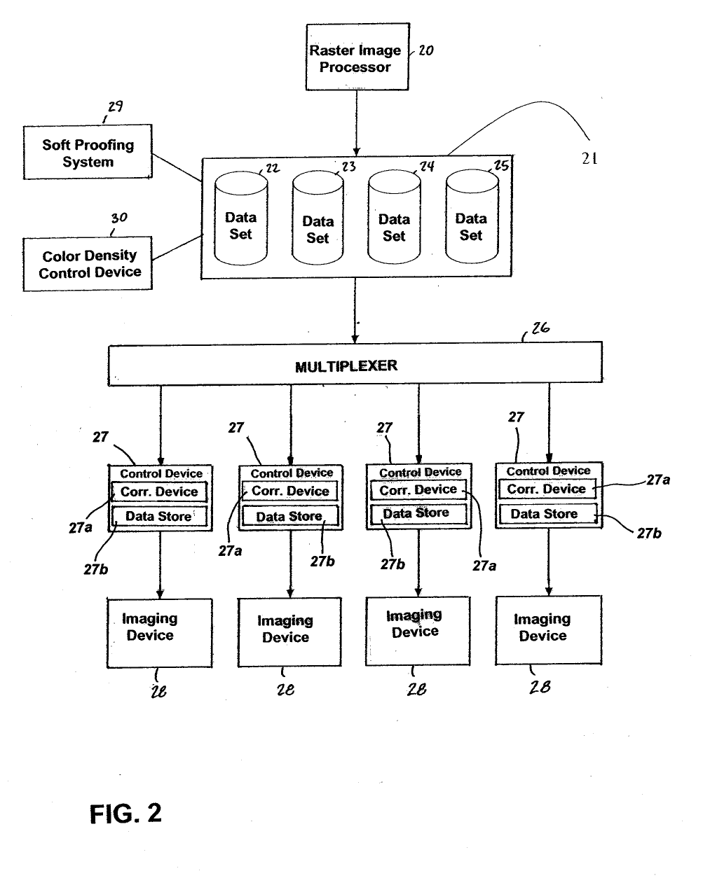

In contrast to the prior art system, FIG. 2 shows the structure of an inventive system for imaging printing plates. The inventive system for imaging printing plates has a raster image processor 20 which breaks down a printing image data set into several color separation data sets. The number of color separation data sets provided by the raster image processor 20 corresponds to the number of colors participating in the printing process. The color separation data sets provided by the raster image processor 20 can be stored in the storage medium 21, where, according to FIG. 2, a total of four color separation data sets 22, 23, 24, and 25 are stored in the storage medium 21. The number of color separation data sets depends, however, as previously mentioned, on the number of colors participating in the printing process.

The color separation data sets 22, 23, 24, and 25 which are stored in the storage medium 21 of the inventive imaging system are uncorrected and therefore printing location-nonspecific color separation data sets.

Each of the color separation data sets 23-25 stored in the storage medium 21 can be sent to a control device 27, where a correction device 27a is integrated into each control device 27 to convert the printing location-nonspecific color separation data set into a printing location-specific color separation data set. This is then used by the control device 27 in question to drive the corresponding imaging device 28. The control devices 27 are therefore designed as control and correction devices.

A data storage medium 27b can also be integrated into each of the control devices 27 in addition to the correction device 27a, so that the printing location-specific color separation data set generated by the correction device 27a integrated into the control device can be stored in the associated control device 27.

According to FIG. 2, the storage medium 21 is connected to the control devices 27 by a multiplexer device 26. Each of the color separation data sets can be assigned selectively to a control device 27, and thus to an imaging device 28, by the multiplexer device 26.

In the inventive system for imaging printing forms, therefore, printing location-nonspecific color separation data sets are corrected to printing location-specific color separation data sets decentrally and in parallel in the control devices 27, which serve to drive the imaging devices 28. That is, each of the color separation data sets for the different colors of inks is corrected separately.

The color separation data sets are therefore printing location-nonspecific until they are corrected in the control devices 27, which means that a flexible assignment of the printing location-nonspecific color separation data sets to individual printing locations is possible. Through the parallelization of the correction in the control devices 27, a shorter throughput time can be realized. In addition, the correction performed to provide the printing location-specific color separation data sets becomes robust, because the correction in question is not conducted until just upstream of the actual printing location. Printing location-specific parameters such as scaling data and geometric data, which are used to correct the printing location-nonspecific color separation data sets and thus to provide the printing location-specific color separation data sets, can be adapted in short cycles, autonomously, in the printing location in question.

The printing location-nonspecific color separation data sets 22-25 stored in the data storage medium 21 can also be made available to other systems of a printing press such as a softproofing system 29 or a color density control device 30. Thus, the color separation data sets 22-25 provided by the raster image processor 20 and stored in the data storage medium 21 can be used multiple times.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for imaging printing forms, comprising:
a raster image processor breaking down a printing image data set into color separation data sets;
a data storage medium for storing the color separation data sets generated by the raster image processor, the color separation data sets being printing location-nonspecific color separation data sets;
control devices and imaging devices, wherein, for the imaging of a printing form on the basis of one of the color separation data sets, each of the control devices drives one of the imaging devices to image the printing form in question; and
a correction device integrated into each of the control devices to convert the printing location-nonspecific color separation data sets stored in the data storage medium into printing location-specific color separation data sets, which can be used to drive the imaging devices.

2. The system of claim 1, wherein each of the control devices also includes a data storage medium so that the printing location-specific color separation data set generated by the correction device can be stored in the each of the control devices.

3. The system of claim 1, further comprising a multiplexer device installed between the data storage medium and the control devices to assign the printing location-nonspecific color separation data sets selectively to the control devices.

4. The system of claim 1 the printing location-nonspecific color separation data sets stored in the data storage medium is available to other systems of a printing press.

5. The system of claim 4, wherein the printing location-nonspecific color separation data sets stored in the data storage medium is made available to a softproofing system.

6. The system of claim 4, wherein the printing location-nonspecific color separation data sets stored in the data storage medium are available to a color density control device.
